(19) United States
(12) Patent Application Publication
(10) Pub. No.: US 2017/0199959 A1
(43) Pub. Date: Jul. 13, 2017

(54) GENETIC ANALYSIS SYSTEMS AND METHODS

(71) Applicant: Seven Bridges Genomics Inc., Cambridge, MA (US)

(72) Inventor: Devin Locke, Medford, MA (US)

(21) Appl. No.: 14/994,758

(22) Filed: Jan. 13, 2016

(51) Int. Cl. G06F 19/14; G06F 19/22

(52) U.S. Cl. CPC G06F 19/14; G06F 19/22

(57) ABSTRACT

Genomes of different species may be embodied as a graph in which conserved parts of multiple genomes are stored at a fixed location in memory and accessed via spatial addressing. The graph branches into plural paths, each defined by pointers to other fixed locations in the memory, where the genomes diverge due to either divergent homology or non-homologous portions. The graph can represent whole genomic information for multiple species with the natural relationships among parts of the genomes being represented by the structure of the graph. Newly obtained sequences such as output from NGS instruments can be mapped onto the graph for assembly or identification.

### TECHNICAL FIELD

The invention relates to systems and methods for genetic analysis using multi-species reference genome graphs.

### BACKGROUND

Contemporary DNA sequencing technology provides a very large quantity of genetic data rapidly. Whole genomes can be sequenced in days and newly-sequenced genomes from across the tree of life are regularly added to public databases such as GenBank. Unfortunately, existing methods only scratch the surface of the amount of information potentially available from that data. Approaches to analyzing genetic information include such strategies as identifying open reading frames in genomes as putative protein coding genes and searching those genes with a tool such as BLAST to attempt to identify them. Further approaches are discussed in Mullikin, 2014, The evolution of comparative genomics, Molecular Genetics and Genomic Medicine 2(5):363-368, incorporated by reference. Existing approaches typically include comparing putative genes to other known genes and inferring that a putative gene is homologous to some known gene based on an adequate match. If enough of their genomes match up, two organisms may be declared to be of the same species or same phylogenetic clade. Through iterations of such inferences, it is hoped that we may someday understand more about living things.

### SUMMARY

Genomes of different species may be embodied as a graph in which conserved parts of multiple genomes are stored as objects in memory. The graph branches into plural paths, each defined by pointers to other objects in the memory, where the genomes diverge due to either divergent homology or non-homologous portions. The graph can represent whole genomic information for multiple species with the natural relationships among parts of the genomes being represented by the structure of the graph. Newly obtained sequences such as output from NGS instruments can be mapped onto the graph for assembly or identification. Each included genome may be represented fully in its natural order by one or more paths corresponding to chromosomes of that genome. For example, genes of an α-proteobacteria may share portions of the graph with genes from animal mitochondrial genomes, which represents and reveals the inferred proteobacterial ancestry of the mitochondrion. As another example, the genomes of each and every organism represented by the graph may all share a portion of the graph corresponding to a ribosomal subunit in accordance with its role in all self-replicating systems as described by Woese and Fox (1977, PNAS 11:5088). Similarly, where viral genetic sequences are related to human endogenous retroviral sequences, the graph can include paths for the human genome and viral genomes that converge at those related elements. It can be seen thus that the graph provides a powerful tool for making sense of genomic sequence data.

Aspects of the invention provide a method for analyzing genetic information. The method includes obtaining a genetic sequence from an organism; aligning—using a processor coupled to a tangible memory subsystem—the genetic sequence to one or more of a plurality of known sequences from a plurality of different species stored as a reference graph comprising objects in the tangible memory subsystem (in which matching homologous segments of the known sequences are each represented by a single object in the reference graph and in which each of the plurality of different species has at least a majority of least one chromosome represented by a path through the reference graph); and providing a report that includes a description of an aspect of the organism (e.g., the identity) based on a result of the aligning step. Aligning the genetic sequence to the one or more of the plurality of known sequences may include using the processor to perform a multi-dimensional look-back operation to find a highest-scoring trace through a multi-dimensional matrix. Since different species are included, chromosomal segments from those species may converge within the reference graph where they include conserved genes and may diverge where one chromosome contains a gene not found in another. Specifically, the method may be implemented using a reference graph in which a first one of the plurality of different species has at least a majority of a first chromosome represented by a first path and a second one of the plurality of different species has at least a majority of a second chromosome represented by a second path through the reference graph, wherein the first chromosome and the second chromosome both comprise a known conserved gene that are represented by a first segment of the reference graph. The first chromosome may include a first gene represented by the reference graph and not found in a genome of the second one of the plurality of different species while the second one of the plurality of different species comprises a second gene represented by the reference graph and not found in a genome of the first one of the plurality of different species.

Optionally, the method may include, prior to the aligning step: obtaining the known sequences from the plurality of different species from an online sequence database; finding and deleting redundancies among homologous portions of the known sequences, leaving the matching homologous segments of the known sequences; and creating one of the objects in the tangible memory subsystem for each of the segments, thereby transforming the known sequences from the online sequence database into the reference graph.

The method may include identifying a specific type of plant or animal that the organism is (e.g., corn, wheat, maize, rapeseed, soybean, sunflower, barley, sorghum, potato, or rice or cattle, horse, goat, sheep, swine, or poultry, respectively).

In some embodiments, the genetic sequence from the organism is one of a plurality of sequence reads and the method further includes aligning some of the plurality of sequence reads to a known conserved gene (such as a ribosomal subunit) in the reference graph and assembling others of the plurality of sequence reads to each other.

In some embodiments, the report further includes information about a population that includes the organism. For example, the report may include an F-statistic describing heterozygosity within the population and the F-statistic is selected from the group consisting of: F_{IS}, F_{ST}, and F_{IT}.

In certain embodiments, the known sequences from the plurality of different species include viral genetic information and human genetic information, wherein the reference graph represents the viral genetic information aligned to human endogenous retrovirus portions of the human genetic information.

In some embodiments, methods of the invention are used in phylogenetics. For example, the method may include identifying a relationship between the organism and one of the plurality of different species. The report may further comprise a phylogenetic tree that depicts the identified relationship. The method may include generating the phylogenetic tree by subjecting the known sequences from the plurality of different species and the genetic sequence from the organism to a phylogenetic inference operation using an approach selected from the group consisting of: maximum likelihood; Bayesian; parsimony; genetic distance; and a genetic algorithm for rapid likelihood inference.

Preferably in any of the embodiments, high-level physical addressing of memory is used and the objects of the reference graph include pointers to adjacent ones of the objects such that the objects are linked into paths to represent the known sequences from the plurality of different species, wherein each pointer identifies a physical location in the memory subsystem at which the adjacent object is stored. Objects of the reference graph may comprise vertex objects connected by edge objects and an adjacency list for each vertex object and edge object in which the adjacency list for a vertex object or edge object lists the edge objects or vertex objects to which that vertex object or edge object is adjacent. Each entry in an adjacency list may be a pointer to the adjacent vertex object or edge object, wherein each pointer identifies a physical location in the memory subsystem at which the adjacent object is stored. In certain embodiments, the reference graph uses index-free adjacency to link the objects into paths to represent the known sequences from the plurality of different species.

In certain aspects, the invention provides a computer system for analyzing genetic information, the system comprising a processor coupled to a tangible memory subsystem have instructions stored therein that when executed by the processor cause the system to: obtain a genetic sequence from an organism and align the genetic sequence to one or more of a plurality of known sequences from a plurality of different species stored as a reference graph. The reference graph includes objects in the tangible memory subsystem in which matching homologous segments of the known sequences are each represented by a single object in the reference graph. Each of the plurality of different species has at least a majority of least one chromosome represented by a path through the reference graph. Aligning the genetic sequence to the one or more of the plurality of known sequences from a plurality of different species may include using the processor to perform a multi-dimensional look-back operation to find a highest-scoring trace through a multi-dimensional matrix. Execution of the instructions further causes the system to provide a report that includes a description of an aspect of the organism (such as the organism's identity) based on a result of the aligning step. Since different species are represented by the system, chromosomal segments from those species may converge within the reference graph where they include conserved genes and may diverge where one chromosome contains a gene not found in another. Thus the system may include the reference graph such that a first one of the plurality of different species has at least a majority of a first chromosome represented by a first path and a second one of the plurality of different species has at least a majority of a second chromosome represented by a second path, wherein the first chromosome and the second chromosome both include a known conserved gene that are represented by a first segment of the reference graph. Moreover, the first chromosome has a first gene represented by the reference graph and not found in a genome of the second one of the plurality of different species while the second one of the plurality of different species comprises a second gene represented by the reference graph and not found in a genome of the first one of the plurality of different species.

In some embodiments, execution of the instructions causes the system to, prior to the aligning step: obtain the known sequences from the plurality of different species from an online sequence database; find and delete redundancies among homologous portions of the known sequences, leaving the matching homologous segments of the known sequences; and create one of the objects in the tangible memory subsystem for each of the segments, thereby transforming the known sequences from the online sequence database into the reference graph.

The system may be used to identify a type of plant that the organism is (e.g., corn, wheat, maize, rapeseed, soybean, sunflower, barley, sorghum, potato, and rice). The system may be used to identify a type of animal that the organism is (e.g., cattle, horse, goat, sheep, swine, and poultry).

In certain embodiments, the genetic sequence from the organism is one of a plurality of sequence reads and the system is operable to align some of the plurality of sequence reads to a known conserved gene (e.g., such as a ribosomal subunit) in the reference graph and assemble others of the plurality of sequence reads to each other, e.g., by a de novo assembly.

In some embodiments, the report further includes information about a population that includes the organism. For example, the report may include an F-statistic describing heterozygosity within the population and the F-statistic may be selected from the group consisting of: F_{IS}, F_{ST}, and F_{IT}.

In certain embodiments, the known sequences from the plurality of different species comprise viral genetic information and human genetic information and the reference graph represents the viral genetic information aligned to human endogenous retrovirus portions of the human genetic information.

In some embodiments, the system is useful for phylogenetic analysis. For example, the system may be operable to identify a relationship between the organism and one of the plurality of different species. The report may include a phylogenetic tree that depicts the identified relationship. The system may be operable to generate the phylogenetic tree by subjecting the known sequences from the plurality of different species and the genetic sequence from the organism to a phylogenetic inference operation using an approach such as maximum likelihood; Bayesian; parsimony; genetic distance; or a genetic algorithm for rapid likelihood inference.

In any of the embodiments, it may be preferable for objects of the reference graph to include pointers to adjacent ones of the objects such that the objects are linked into paths to represent the known sequences from the plurality of different species, wherein each pointer identifies a physical location in the memory subsystem at which the adjacent object is stored. For example, objects of the reference graph may include vertex objects connected by edge objects and the system may include an adjacency list for each vertex object and edge object, wherein the adjacency list for a vertex object or edge object lists the edge objects or vertex objects to which that vertex object or edge object is adjacent (such that, for example, each entry in an adjacency list is a pointer to the adjacent vertex object or edge object, wherein each pointer identifies a physical location in the memory subsystem at which the adjacent object is stored). In certain embodiments, the reference graph uses index-free adjacency to link the objects into paths to represent the known sequences from the plurality of different species.

### BRIEF DESCRIPTION OF THE DRAWINGS

FIG. 1 diagrams a method for analyzing genetic information.

FIG. 2 shows transforming a plurality of known sequences from different species into a multi-species reference graph.

FIG. 3 shows a multi-species graph according to preferred embodiments.

FIG. 4 shows a computer system for performing methods of the invention.

FIG. 5 shows the use of an adjacency list for each vertex.

FIG. 6 shows the use of an adjacency list for each vertex and edge.

FIG. 7 illustrates obtaining a genetic sequence from an organism.

FIG. 8 shows aligning a genetic sequence to a multi-species genome graph.

FIG. 9 shows the matrices that represent an alignment.

FIG. 10 illustrates a report that may be generated.

FIG. 11 illustrates a report that may be produced.

### DETAILED DESCRIPTION

Standard bioinformatics techniques have not been good at answering questions that involve demarcating the boundaries of a species or that involve incorporating genetic information that crosses the boundaries between species. Those questions arise in the field of metagenomics among others. Graphs may be used as a tool in answering bioinformatic questions from metagenomics, phylogenetics, population genetics, comparative genomics, basic organismal biology and other fields.

One concern has been that traditional techniques are not naturally suited for distinguishing species. Collecting and analyzing linear genomes as linear genomes provides little natural apparatus by which to adjudicate questions about whether or not a given genome belongs or does not belong to a given species.

Additionally, the status quo makes it difficult to synthesize information from many genomes at once. That is particularly true in the case of using information from other species in analyses involving a given species. The invention includes the insight that it may be desirable when considering a bioinformatic question about a given species or sample to use information that is not specific to the species at hand. In some cases this is because there are genetic similarities between species. In other cases, genetic information is not intrinsically about any particular species. For example, a gene may be studied that codes for something that appears across multiple species with little or no variation appearing across those species.

It is slow to incorporate information from many human genomes (or many genomes of another species) using the status quo. The problem is only magnified in cases where it is desirable to incorporate information both from many genomes of a given species and from many genomes of other species.

Exemplary circumstances in which systems and methods of the invention are applicable include the comparison of viral sequences to human endogenous retroviruses (HERVs). A great deal of human genetic information (on the order of 5% of the human genome) consists of HERVs. Those elements either are identical to viral genomes or are closely related to them. It is therefore valuable to compare viral genetic information to human genetic information for the purposes of assembly, alignment, and any number of other problems. The more accurately the relationship between viral sequences and virus-derived human sequences is described, the more can be understood about the evolutionary history and functional characteristics of those human sequences. Considering HERV elements in the context of a full human genome can yield valuable information. For example, information that depends not only on the virus-derived sequence but also on that sequence's location in the genome or proximity to some other sequence may be revealed. The invention provides tools for the study of interaction at a distance in the genome and in the ways that function supervenes on spatially distant parts of the genome.

Other exemplary circumstances in which systems and methods of the invention are applicable include human-primate genetic analysis. It is often noted that the human genome is roughly 99% identical to the chimpanzee genome. This means that a graph containing both chimpanzee and human genomes will have a similar structure to a human-only graph insofar as many of the genomes incorporated in the graph with be almost entirely similar. Interspecies graphs of this type thus will have much of the natural compression advantages of intraspecies graphs but may also contain useful information about genetic variation in closely related species.

Additional exemplary circumstances in which systems and methods of the invention are applicable include the analysis of highly conserved genes. Certain highly conserved genetic sequences are found across species. Famous examples of this include sequences that code for biological elements that are common to many species such as sequences that code for parts of ribosomes, such as 16S rRNA. As described in co-owned and co-pending U.S. Provisional Application 62/174,208, a graph of 16S sequences from many different species could both allow nuanced species identifications and could also reveal information about how the sequence changes across species.

Embodiments of the invention provide a variety of graph-based techniques for genetic analysis.

In some embodiments, systems and methods of the invention make use of a multi-species reference graph. The graph may be a directed graph and in some embodiments is implemented as a directed acyclic graph (DAG). One can create a reference graph covering all or part of the genomes of several species. For example, one could create a human/ape graph by similar processes to those by which we would create a human-only graph. We could then align against this graph as we would align to a human-only graph, perhaps applying a penalty in cases where matches in a candidate alignment are to bases found only in genomes of another species. There has been widespread interest in the study of Neanderthal and other genomes for their own sakes, and methods of the invention allow more detailed and substantive comparisons of, e.g., modern human and Neanderthal genomes. Those methods also allow more accurate and rapid comparisons of newly discovered species to other species (e.g., in the case of beetles).

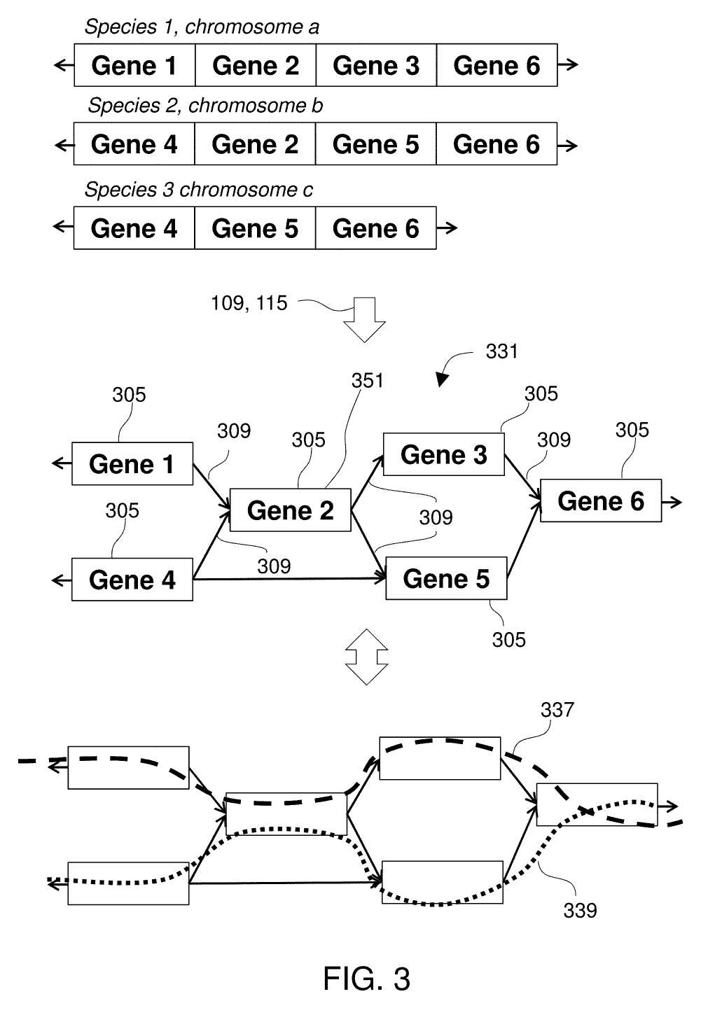

In certain embodiments, the invention provides for the use of species-agnostic regional DAGs to construct multi-species DAGs. One can create a DAG involving, for example, any 16S sequence, where sequences are chosen for inclusion in the DAG only by virtue of their being identified as 16S sequences. One can then align against this DAG (as when one has a metagenomic sample and wants to identify the species present by analyzing the 16S sequences in the sample). A multi-species DAG embeds the relevant information in the context of a full genome or a large part of a genome (e.g., as discussed in detail below in connection with FIG. 3) allows for fundamentally different and richer kinds of analysis.

A multi-species genome graph of the invention may be used for any suitable inquiry. Exemplary types of inquiries that may be addressed using a multi-species genome graph include identifying relationships among related species and newly identified species (e.g., from recent fossils). An example here would be with non-homo-sapiens human species, where this kind of analysis could be used to better sequence newly discovered species, identify relationships among the species, and situate newly discovered species among the others. A multi-species genome graph may be used for questions of species identification in the agricultural sector (identifying fish, unknown meat, plants (crops), strain identification in plants, invasive species monitoring) or animal breeding (distinguishing breeds of horses, dogs, or other animals). Other uses for a multi-species genome graph include conservation research. Such a graph may be used to research population variation within populations such as orangutans, for example, to monitor genetic health of endangered populations. Such graphs may be sometimes intraspecies and sometimes interspecies (e.g., two species of orangutan).

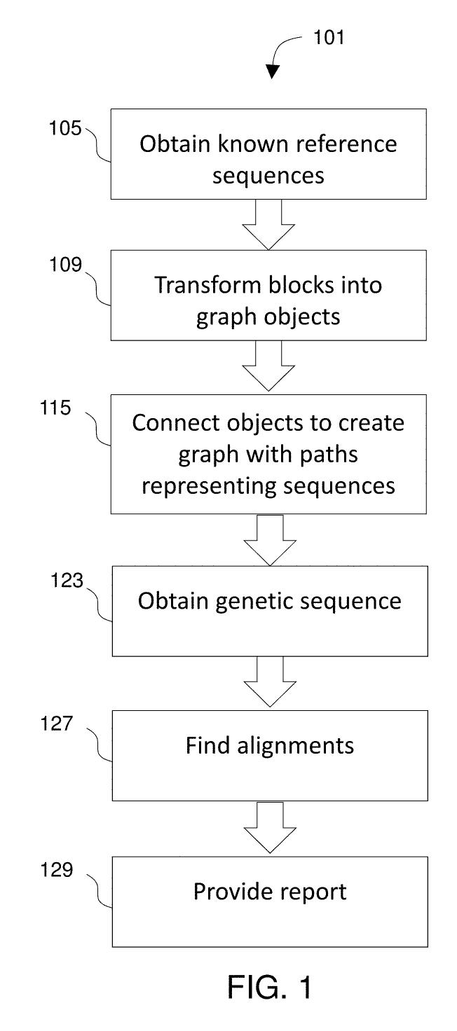

FIG. 1 diagrams a method 101 for analyzing genetic information. The method 101 includes obtaining 105 a plurality of known sequences from a plurality of different species. Places where those species match when aligned—i.e., matching homologous segments—define blocks that are transformed 109 into objects. The objects are connected 115 in order to create paths through the connected blocks such that there is a path to represent each of the plurality of known sequences from the plurality of different species. Thus the plurality of known sequences from the plurality of different species are stored as a reference graph comprising objects in the tangible memory subsystem, wherein matching homologous segments of the known sequences are each represented by a single object in the reference graph.

The method 101 further includes obtaining 123 a genetic sequence from an organism and finding alignments 127 between the genetic sequence and the plurality of known sequences from the plurality of different species. A report is provided 129 that includes a description of an aspect of the organism based on a result of the aligning step.

The invention provides methods for creating a reference graph.

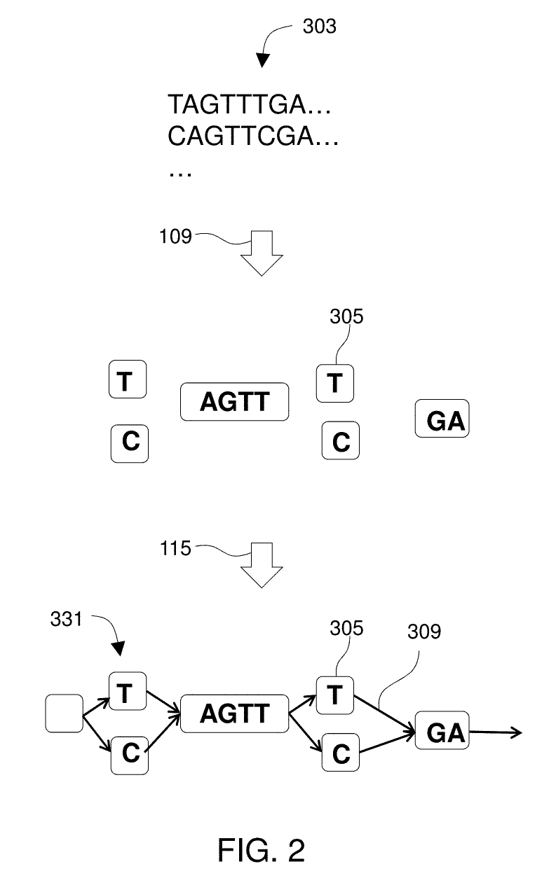

FIG. 2 illustrates obtaining 105 a plurality of known sequences 303 from a plurality of different species and transforming 109 the known sequences 303 into a multi-species reference graph 331 that includes vertex objects 305 and edge objects 309. The known sequences 303 may be retrieved from a database. For example, a computer system may be used to execute instructions (e.g., using SQL, Perl, Python, or similar suitable scripting and query platform) to retrieve genome sequence data from the NCBI genomes database.

Each of the known sequences 303 are aligned to one another (e.g., top panel of FIG. 2), preferably by being aligned to an object containing information from each other sequence. In a preferred embodiment, the sequences are aligned by the process of building them into the reference graph 331 using the modified multi-dimensional Smith Waterman operation defined herein. In some embodiments, it may be useful or convenient to perform a multiple sequence alignment among known sequences 303, e.g., using Clustal. Multiple sequence alignment is discussed in more detail below. Matching homologous segments are identified as blocks and those blocks are transformed 109 into objects 305 that are stored in a tangible memory device.

In the fragments of known sequence 303 represented in FIG. 2, it can be seen that bases 2-5 of first sequence align to, and match, bases 2-5 of the second sequence. Thus those segments of those two sequences are identified as a block and systems of the invention create an object 305 to represent that AGTT string. It is noted that this object could potentially be stored using one byte of information. For example, if A=00, C=01, G=10, and T=11, then this block contains 00101111 (one byte). Where the original known sequences 303 contain thousands of genomes, the described methods provide a considerable improvement to the operation of the computer system in comparison to a prior art method that stores an entire multiple sequence alignment.

The objects 305 are connected 115 to create paths such that there is a path for each of the original known sequences 303. The paths are directed and preferably in the sense that the direction of each path corresponds to the 5′ to 3′ directionality of the nucleic acid represented by the known sequence. However, it is noted that it may be convenient or desirable to represent a path in a 3′ to 5′ direction and that doing so does not leave the scope of the invention. The connections creating the paths can themselves be implemented as objects so that the blocks are represented by vertex objects 305 and the connections are represented by edge objects 309. Thus the directed graph comprises vertex and edge objects stored in the tangible memory device. The multi-species reference graph 331 represents the plurality of known sequences 303 in that each one of the original sequences can be retrieved by reading a path in the direction of that path. However, the multi-species reference graph 331 is a different article than the original known sequences 303, at least in that portions of the sequences that match each other when aligned (i.e., matching homologous portions of the sequences) have been transformed into single objects 305. Thus if the original article includes 90,000 full genomes in which a gene segment is perfectly conserved for a span of 12,000 bp across all of the genomes, then over 1 billion characters of information from the original article are transformed into a single object that can use less than 3 KB on disk. It will be appreciated that the foregoing description of FIG. 2 can be applied to describe obtaining known sequences from a plurality of different species from an online sequence database such as GenBank and then finding and deleting redundancies among homologous portions of the known sequences, leaving the matching homologous segments of the known sequences. This may further include creating one of the objects in the tangible memory subsystem for each of the segments, thereby transforming the known sequences from the online sequence database into the reference graph.

In preferred embodiments, the reference graph 331 represents chromosomal segments of different species that partly overlap while also partly diverging. That is, two or more species' genomes may be included (at least in substantial portions such as at least a majority of at least one chromosome of interest).

FIG. 3 illustrates a reference graph 331 that includes a first path 337 that represents at least a majority of a first chromosome, chromosome a, from a first species, Species 1. The graph 331 also includes a second path 339 that represents at least a majority of a second chromosome, chromosome b, from a second species, Species 2. The top portion of FIG. 3 is a genetic map of chromosomal segments of three species, Species 1, Species 2, and Species 3, and thus constitutes one example of a set of known sequences 303. The middle portion of FIG. 3 shows the reference graph 331. The bottom portion of FIG. 3 is a cartoon re-drawing of the reference graph 331 with the first path 337 and the second path 339 overlaying the drawing to aid in visualization and understanding. The first path 337 and the second path 339 exist within the reference graph 331 shown in the middle portion. Each of the first path 337 and the second path 339 comprises a series of vertex objects 305 connected by edge objects 309. Thus FIG. 3 depicts a plurality of known sequences 303 from a plurality of different species stored as a reference graph 331. The reference graph 331 includes objects 305, 309 in the tangible memory subsystem in which matching homologous segments of the known sequences 303 are each represented by a vertex object 305 in the reference graph 331. Each of the plurality of different species has at least a majority of least one chromosome represented by a path 337, 339 through the reference graph 331. Since different species are represented by the reference graph 331, chromosomal segments from those species may converge within the reference graph where they include conserved genes and may diverge where one chromosome contains a gene not found in another. For example, Species 1, Species 2, and Species 3 all include Gene 6, which is represented using only a single vertex object 305 in the reference graph 331. With attention to Species 1 and Species 2 that both include Gene 2, the system includes the reference graph 331 such that a first one of the plurality of different species (Species 1) has at least a majority of a first chromosome (chromosome a) represented by a first path 337 and a second one of the plurality of different species (Species 2) has at least a majority of a second chromosome (chromosome b) represented by a second path 339, wherein the first chromosome and the second chromosome both include a known conserved gene (Gene 2) that are represented by a first segment 351 of the reference graph. Moreover, the first chromosome has at least a first gene (Gene 1) represented by the reference graph and not found in a genome of the second one of the plurality of different species (Species 2) while the second one of the plurality of different species (Species 2) comprises a second gene (Gene 4) represented by the reference graph and not found in a genome of the first one of the plurality of different species (Species 1). Since different species are represented by the system, chromosomal segments from those species may converge within the reference graph where they include conserved genes and may diverge where one chromosome contains a gene not found in another.

A reference graph, which may be a directed acyclic graph (DAG), thus operates as a regional graph in that it may depict inter-relationships among numerous regions of different genomes across those regions. The regional inter-relationships provide a useful starting point for building comprehensive multi-species reference graphs 331. For example, one may “seed” a DAG with a sequence that one knows to be at least partially conserved across species, add other sequences that are sufficiently similar to that sequence (regardless of their origin), and then add the remainder of the longer sequences (e.g., a whole genome or chromosome) of which the conserved sequences are a part. In this way, these highly conserved sequences are used as anchor points between the genomes of different species in an interspecies DAG, with the location of the conserved sequences serving as guideline for the relative alignment of the divergent sequences, significantly reducing the computational complexity of constructing a multispecies DAGs.

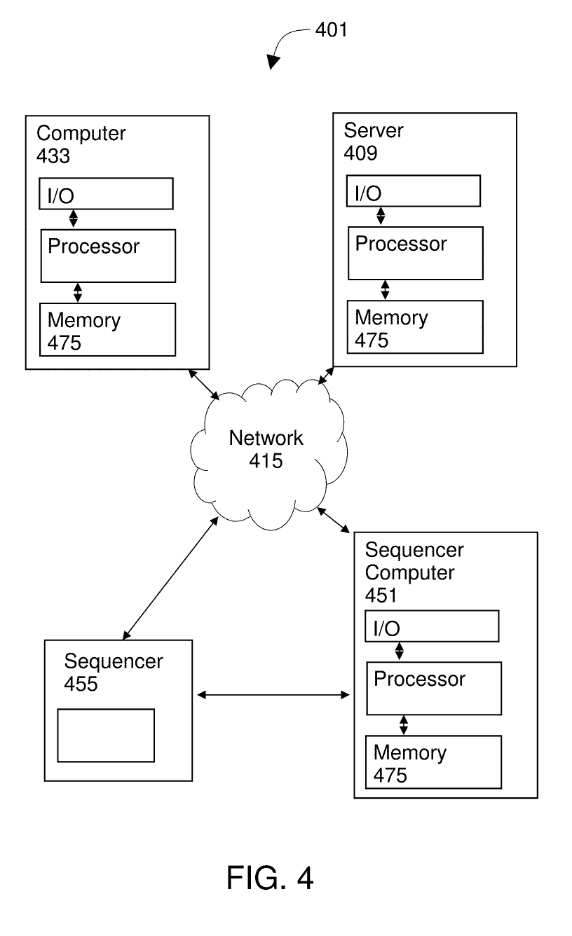

It should be noted that FIG. 3 depicts an example of several simplified chromosomes in order to highlight that certain regions, subsets, or portions of genomes (or combinations thereof) may be conserved across species. In certain embodiments, systems and methods according to the disclosure may also identify conserved regions between any portions of chromosomes of several species. For example, conserved regions may comprise intergenic regions, intragenic regions, promoter regions, coding regions, non-coding regions, regulatory regions, subsets of these regions, single nucleotides, and the like. FIG. 4 illustrates a computer system 401 suitable for performing methods of the invention. The system 401 includes at least one computer 433. Optionally, the system 401 may further include one or more of a server computer 409 and a sequencer 455, which may be coupled to a sequencer computer 451. Each computer in the system 401 includes a processor coupled to a memory device and at least one input/output device. Thus the system 401 includes at least one processor coupled to a memory subsystem (e.g., a memory device or collection of memory devices 475). Using those mechanical components, the system 401 is perable to obtain a sequence generated by sequencing nucleic acid from a genome of a patient. The system uses the processor to transform the known sequences 303 into the multi-species genome graph 331.

Processor refers to any device or system of devices that performs processing operations. A processor will generally include a chip, such as a single core or multi-core chip, to provide a central processing unit (CPU). A processor may be provided by a chip from Intel or AMID. A processor may be any suitable processor such as the microprocessor sold under the trademark XEON E7 by Intel (Santa Clara, Calif.) or the microprocessor sold under the trademark OPTERON 6200 by AMD (Sunnyvale, Calif.).

The memory subsystem 475 contains one or any combination of memory devices. A memory device is a mechanical device that stores data or instructions in a machine-readable format. Memory may include one or more sets of instructions (e.g., software) which, when executed by one or more of the processors of the disclosed computers can accomplish some or all of the methods or functions described herein. Preferably, each computer includes a non-transitory memory device such as a solid state drive, flash drive, disk drive, hard drive, subscriber identity module (SIM) card, secure digital card (SD card), micro SD card, or solid-state drive (SSD), optical and magnetic media, others, or a combination thereof.

Using the described components, the system 401 is operable to produce a report and provide the report to a user via an input/output device. An input/output device is a mechanism or system for transferring data into or out of a computer. Exemplary input/output devices include a video display unit (e.g., a liquid crystal display (LCD) or a cathode ray tube (CRT)), a printer, an alphanumeric input device (e.g., a keyboard), a cursor control device (e.g., a mouse), a disk drive unit, a speaker, a touchscreen, an accelerometer, a microphone, a cellular radio frequency antenna, and a network interface device, which can be, for example, a network interface card (NIC), Wi-Fi card, or cellular modem.

Preferably the reference graph 331 is stored in the memory subsystem 475 using adjacency techniques, which may include pointers to identify a physical location in the memory subsystem 475 where each vertex is stored. In a preferred embodiment, the graph is stored in the memory subsystem 475 using adjacency lists. In some embodiments, there is an adjacency list for each vertex. For discussion of implementations see ‘Chapter 4, Graphs’ at pages 515-693 of Sedgewick and Wayne, 2011, Algorithms, 4th Ed., Pearson Education, Inc., Upper Saddle River N.J., 955 pages, the contents of which are incorporated by reference and within which pages 524-527 illustrate adjacency lists.

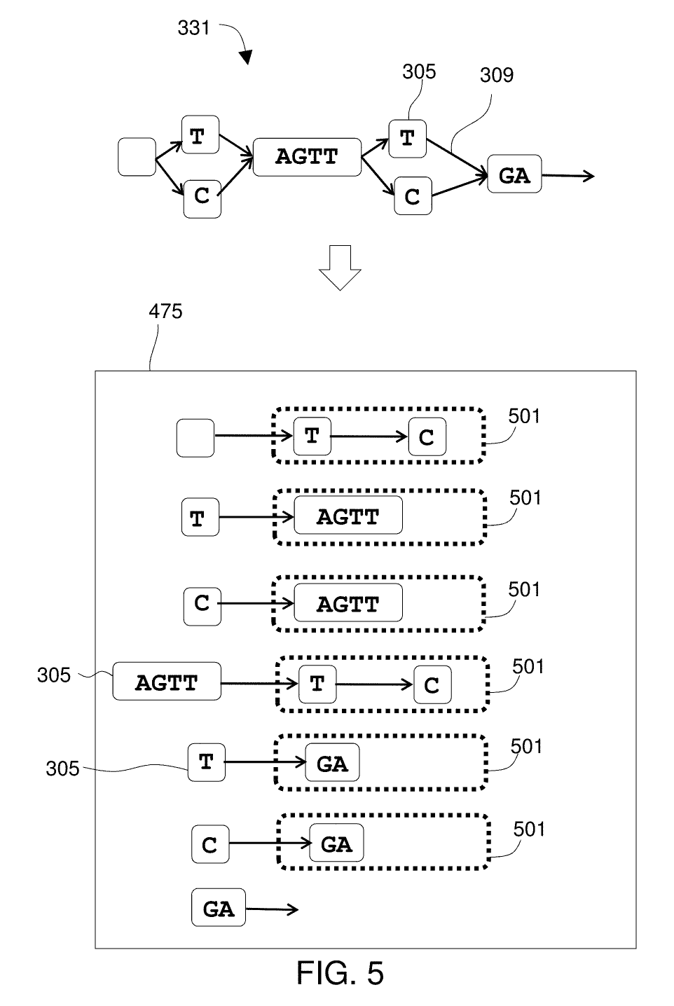

FIG. 5 shows the use of an adjacency list 501 for each vertex 305. The system 401 uses a processor to create a multi-species genome graph 331 that includes vertex objects 305 and edge objects 309 through the use of adjacency, i.e., adjacency lists or index free adjacency. Thus, the processor may create the multi-species genome graph 331 using index-free adjacency wherein a vertex 305 includes a pointer to another vertex 305 to which it is connected and the pointer identifies a physical location in on a memory device 475 where the connected vertex is stored. The multi-species genome graph 331 may be implemented using adjacency lists such that each vertex or edge stores a list of such objects that it is adjacent to. Each adjacency list comprises pointers to specific physical locations within a memory device for the adjacent objects.

In the top part of FIG. 5, the multi-species genome graph 331 is illustrated in a cartoon-like visual-friendly format. The multi-species genome graph 331 will typically be stored on a physical device of memory subsystem 475 in a fashion that provide for very rapid traversals. In that sense, the bottom portion of FIG. 5 is not cartoon-like and represents that objects are stored at specific physical locations on a tangible part of the memory subsystem 475. Each node or vertex 305 is stored at a physical location, the location of which is referenced by a pointer in any adjacency list 501 that references that node. Each node or vertex 305 has an adjacency list 501 that includes every adjacent node in the multi-species genome graph 331. The entries in the list 501 are pointers to the adjacent nodes.

In certain embodiments, there is an adjacency list for each vertex and edge and the adjacency list for a vertex or edge lists the edges or vertices to which that vertex or edge is adjacent.

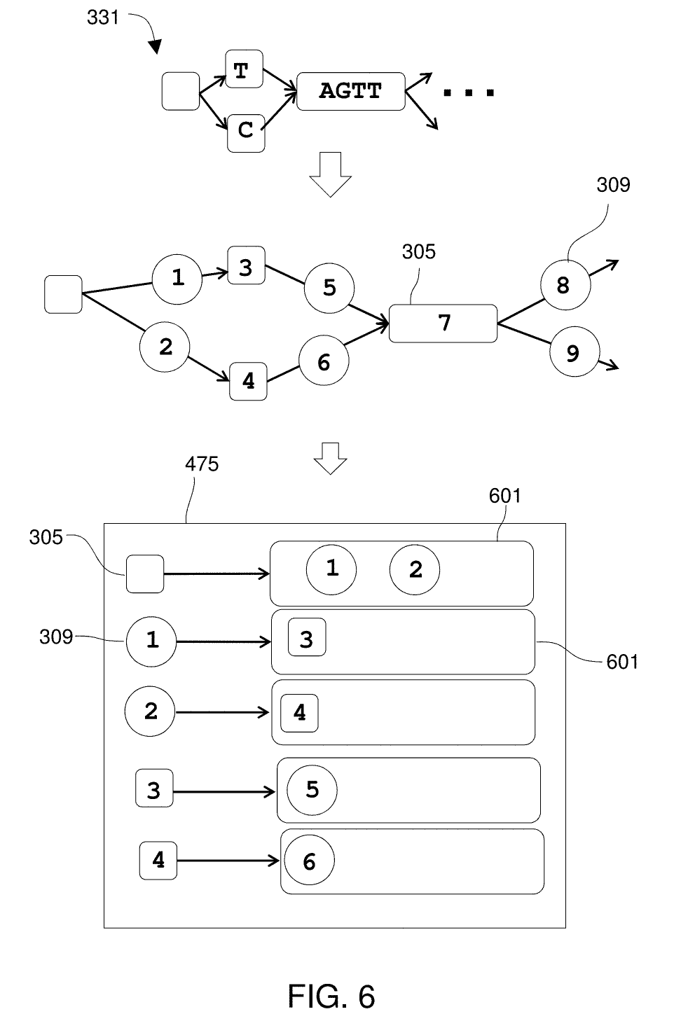

FIG. 6 shows the use of an adjacency list 601 for each vertex 305 and edge 309. As shown in FIG. 6, system 401 creates the multi-species genome graph 331 using an adjacency list 601 for each vertex and edge, wherein the adjacency list 601 for a vertex 305 or edge 309 lists the edges or vertices to which that vertex or edge is adjacent. Each entry in adjacency list 601 is a pointer to the adjacent vertex or edge.

Preferably, each pointer identifies a physical location in the memory subsystem at which the adjacent object is stored. In the preferred embodiments, the pointer or native pointer is manipulatable as a memory address in that it points to a physical location on the memory and permits access to the intended data by means of pointer dereference. That is, a pointer is a reference to a datum stored somewhere in memory; to obtain that datum is to dereference the pointer. The feature that separates pointers from other kinds of reference is that a pointer's value is interpreted as a memory address, at a low-level or hardware level. The speed and efficiency of the described graph genome engine allows a sequence to be queried against a large-scale multi-species genome graph 331 representing millions or billions of bases, using a computer system 401. Such a graph representation provides means for fast random access, modification, and data retrieval.

In some embodiments, fast random access is supported and graph object storage are implemented with index-free adjacency in that every element contains a direct pointer to its adjacent elements (e.g., as described in U.S. Pub. 2014/0280360 and U.S. Pub. 2014/0278590, each incorporated by reference), which obviates the need for index look-ups, allowing traversals (e.g., as done in the modified SW alignment operation described herein) to be very rapid. Index-free adjacency is another example of low-level, or hardware-level, memory referencing for data retrieval (as required in alignment and as particularly pays off in terms of speed gains in the modified, multi-dimensional Smith-Waterman alignment described below). Specifically, index-free adjacency can be implemented such that the pointers contained within elements are references to a physical location in memory.

Since a technological implementation that uses physical memory addressing such as native pointers can access and use data in such a lightweight fashion without the requirement of separate index tables or other intervening lookup steps, the capabilities of a given computer, e.g., any modern consumer-grade desktop computer, are extended to allow for full operation of a genomic-scale graph (i.e., a multi-species reference graph 331 that represents all loci in a substantial portion of the genome). Thus storing graph elements (e.g., nodes and edges) using a library of objects with native pointers or other implementation that provides index-free adjacency actually improves the ability of the technology to provide storage, retrieval, and alignment for genomic information since it uses the physical memory of a computer in a particular way.

While no specific format is required for storage of a graph, FIGS. 4 and 5 are presented to illustrate useful formats. With reference back to FIG. 1, it is noted that methods of the invention use the stored graph with sequence reads that are obtained from a subject. In some embodiments, sequence reads are obtained as an electronic article, e.g., uploaded, emailed, or FTP transferred from a lab to system 401. In certain embodiments, sequence reads are obtained by sequencing.

Methods may include using a multi-species reference graph as an optional preliminary step and then using a reference graph for the analysis of genetic sequences such as sequence reads.

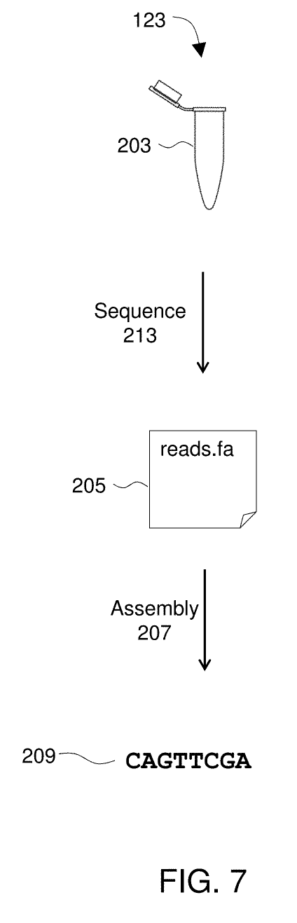

FIG. 7 illustrates obtaining 123 sequence reads 205 from a sample 203. As a preliminary step (not depicted), nucleic acid may be isolated and/or enriched.

In certain embodiments, sequence reads are obtained by performing sequencing 213 on a sample 203 from a subject (however in some embodiments, sequence reads are obtained when a read file is transferred into a system of the invention). Sequencing may be by any method and sequencing instrument known in the art. See, generally, Quail, et al., 2012, A tale of three next generation sequencing platforms: comparison of Ion Torrent, Pacific Biosciences and Illumina MiSeq sequencers, BMC Genomics 13:341. DNA sequencing techniques include classic dideoxy sequencing reactions (Sanger method) using labeled terminators or primers and gel separation in slab or capillary, sequencing by synthesis using reversibly terminated labeled nucleotides, pyrosequencing, 454 sequencing, Illumina/Solexa sequencing, allele specific hybridization to a library of labeled oligonucleotide probes, sequencing by synthesis using allele specific hybridization to a library of labeled clones that is followed by ligation, real time monitoring of the incorporation of labeled nucleotides during a polymerization step, polony sequencing, and SOLiD sequencing.

A sequencing technique that can be used includes, for example, use of sequencing-by-synthesis systems and sequencing instruments sold under the trademarks GS JUNIOR, GS FLX+ and 454 SEQUENCING by 454 Life Sciences, a Roche company (Branford, Conn.), and described by Margulies, M. et al., Genome sequencing in micro-fabricated high-density picotiter reactors, Nature, 437:376-380 (2005); U.S. Pat. No. 5,583,024; U.S. Pat. No. 5,674,713; and U.S. Pat. No. 5,700,673, each incorporated by reference. 454 sequencing involves two steps. First, DNA is sheared into blunt-end fragments attached to capture beads and then amplified in droplets. Second, pyrosequencing is performed on each DNA fragment in parallel. Addition of nucleotides generates a light signal that is recorded by a CCD camera in a sequencing instrument.

Another sequencing technique and instrument that can be used is SOLiD technology by Applied Biosystems from Life Technologies Corporation (Carlsbad, Calif.). In SOLiD sequencing, genomic DNA is sheared into fragments, and adaptors are attached to generate a fragment library. Clonal bead populations are prepared in microreactors containing beads, primers, template, and PCR components. Following PCR, the templates are denatured and enriched and the sequence is determined by a process that includes sequential hybridization and ligation of fluorescently labeled oligonucleotides.

Another example of a DNA sequencing technique and instrument that can be used is ion semiconductor sequencing using, for example, a system sold under the trademark ION TORRENT by Ion Torrent by Life Technologies (South San Francisco, Calif.). Ion semiconductor sequencing is described, for example, in Rothberg, et al., An integrated semiconductor device enabling non-optical genome sequencing, Nature 475:348-352 (2011); U.S. Pubs. 2009/0026082, 2009/0127589, 2010/0035252, 2010/0137143, 2010/0188073, 2010/0197507, 2010/0282617, 2010/0300559, 2010/0300895, 2010/0301398, and 2010/0304982, each incorporated by reference. DNA is fragmented and given amplification and sequencing adapter oligos. The fragments can be attached to a surface. Addition of one or more nucleotides releases a proton (H+), which signal is detected and recorded in a sequencing instrument.

Another example of a sequencing technology that can be used is Illumina sequencing. Illumina sequencing is based on the amplification of DNA on a solid surface using fold-back PCR and anchored primers. Genomic DNA is fragmented and attached to the surface of flow cell channels. Four fluorophore-labeled, reversibly terminating nucleotides are used to perform sequential sequencing. After nucleotide incorporation, a laser is used to excite the fluorophores, and an image is captured and the identity of the first base is recorded. Sequencing according to this technology is described in U.S. Pub. 2011/0009278, U.S. Pub. 2007/0114362, U.S. Pub. 2006/0024681, U.S. Pub. 2006/0292611, U.S. Pat. No. 7,960,120, U.S. Pat. No. 7,835,871, U.S. Pat. No. 7,232,656, U.S. Pat. No. 7,598,035, U.S. Pat. No. 6,306,597, U.S. Pat. No. 6,210,891, U.S. Pat. No. 6,828,100, U.S. Pat. No. 6,833,246, and U.S. Pat. No. 6,911,345, each incorporated by reference.

Other examples of a sequencing technology that can be used include the single molecule, real-time (SMRT) technology of Pacific Biosciences (Menlo Park, CA) and nanopore sequencing as described in Soni and Meller, 2007 Clin Chem 53:1996-2001.

As shown in FIG. 7, sequencing 213 generates a plurality of reads 205. Reads according to the invention generally include sequences of nucleotide data anywhere from tens to thousands of bases in length. Reads may be stored in any suitable format such as, for example, FASTA or FASTQ format. FASTA is originally a computer program for searching sequence databases and the name FASTA has come to also refer to a standard file format. See Pearson & Lipman, 1988, Improved tools for biological sequence comparison, PNAS 85:2444-2448. A sequence in FASTA format begins with a single-line description, followed by lines of sequence data. The description line is distinguished from the sequence data by a greater-than (“>”) symbol in the first column. FASTQ files are similar to FASTA but further include a line of quality scores. Typically, sequence reads will be obtained 123 in a format such as FASTA, FASTQ, or similar.

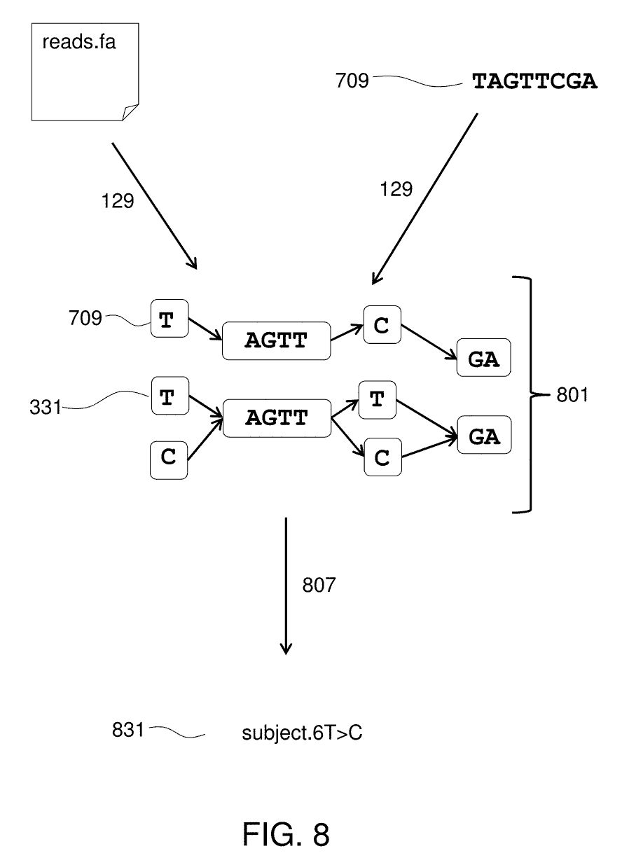

FIG. 8 illustrates finding 129 alignments 801 between the sequence 205 (or a consensus sequence 209 from assembling the reads 205) and the multi-species genome graph 331. FIG. 8 also illustrates an optional variant calling 807 step to identify a subject genotype 831. Using alignment operations of the invention, reads can be rapidly mapped to the multi-species genome graph 331 despite their large numbers or short lengths. Numerous benefits obtain by using a graph as a reference. For example, aligning against a graph is more accurate than aligning against a linear reference and then attempting to adjust one's results in light of other extrinsic information. This is primarily because the latter approach enforces an unnatural asymmetry between the sequence used in the initial alignment and other information. Aligning against an object that potentially represents all the relevant physical possibilities is much more computationally efficient than attempting to align against a linear sequence for each physical possibility (the number of such possibilities will generally be exponential in the number of junctions). A modified Smith-Waterman operation for comparing a sequence to a reference graph is provided here as an extension of pairwise alignment methods.

Pairwise alignment generally involves placing one sequence along part of target, introducing gaps according to an algorithm, scoring how well the two sequences match, and preferably repeating for various positions along the reference. The best-scoring match is deemed to be the alignment and represents an inference of homology between aligned portions of the sequences. In some embodiments, scoring an alignment of a pair of nucleic acid sequences involves setting values for the probabilities of substitutions and indels. When individual bases are aligned, a match or mismatch contributes to the alignment score by a substitution score, which could be, for example, 1 for a match and −0.33 for a mismatch. An indel deducts from an alignment score by a gap penalty, which could be, for example, −1. Gap penalties and substitution probabilities can be based on empirical knowledge or a priori assumptions about how sequences evolve. Their values affect the resulting alignment. Particularly, the relationship between the gap penalties and substitution probabilities influences whether substitutions or indels will be favored in the resulting alignment.

Stated formally, an alignment represents an inferred relationship between two sequences, x and y. For example, in some embodiments, an alignment A of sequences x and y maps x and y respectively to another two strings x′ and y′ that may contain spaces such that: (i) |x′|=|y′|; (ii) removing spaces from x′ and y′ should get back x and y, respectively; and (iii) for any i, x′[i] and y′[i] cannot be both spaces.

A gap is a maximal substring of contiguous spaces in either x′ or y′. An alignment A can include the following three kinds of regions: (i) matched pair (e.g., x′[i]=y′[i]; (ii) mismatched pair, (e.g., x′[i]≠y′[i] and both are not spaces); or (iii) gap (e.g., either x′[i . . . j] or y′[i . . . j] is a gap). In certain embodiments, only a matched pair has a high positive score a. In some embodiments, a mismatched pair generally has a negative score b and a gap of length r also has a negative score g+rs where g, s<0. For DNA, one common scoring scheme (e.g. used by BLAST) makes score a=1, score b=−3, g=−5 and s=−2. The score of the alignment A is the sum of the scores for all matched pairs, mismatched pairs and gaps. The alignment score of x and y can be defined as the maximum score among all possible alignments of x and y.

Any pair may have a score defined by a 4x4 matrix B of substitution probabilities. For example, B(i,i)=1 and 0<B(i,j)<1[for i≠j], is one possible scoring system. For instance, where a transition is thought to be more biologically probable than a transversion, matrix B could include B(C,T)=0.7 and B(A,T)=0.3, or other values desired or determined by methods known in the art.

A pairwise alignment, generally, involves—for sequence Q (query) having m characters and a reference genome T (target) of n characters≠finding and evaluating possible local alignments between Q and T. For any 1≦i≦n and 1≦j≦m, the largest possible alignment score of T[h . . . i] and Q[k . . . j], where h≦i and k≦j, is computed (i.e. the best alignment score of any substring of T ending at position i and any substring of Q ending at position j). This can include examining all substrings with cm characters, where c is a constant depending on a similarity model, and aligning each substring separately with Q. Each alignment is scored, and the alignment with the preferred score is accepted as the alignment. One of skill in the art will appreciate that there are exact and approximate algorithms for sequence alignment. Exact algorithms will find the highest scoring alignment, but can be computationally expensive. Two well-known exact algorithms are Needleman-Wunsch (J Mol Biol, 48(3):443-453, 1970) and Smith-Waterman (J Mol Biol, 147(1):195-197, 1981; Adv. in Math. 20(3), 367-387, 1976). A further improvement to Smith-Waterman by Gotoh (J Mol Biol, 162(3), 705-708, 1982) reduces the calculation time from O(m̂2n) to O(mn) where m and n are the sequence sizes being compared and is more amendable to parallel processing. In the field of bioinformatics, it is Gotoh's modified algorithm that is often referred to as the Smith-Waterman algorithm. Smith-Waterman approaches are being used to align larger sequence sets against larger reference sequences as parallel computing resources become more widely and cheaply available. See, e.g., Amazon's cloud computing resources. All of the journal articles referenced herein are incorporated by reference in their entireties.

The original Smith-Waterman (SW) algorithm aligns linear sequences by rewarding overlap between bases in the sequences, and penalizing gaps between the sequences. Smith-Waterman also differs from Needleman-Wunsch, in that SW does not require the shorter sequence to span the string of letters describing the longer sequence. That is, SW does not assume that one sequence is a read of the entirety of the other sequence. Furthermore, because SW is not obligated to find an alignment that stretches across the entire length of the strings, a local alignment can begin and end anywhere within the two sequences.

The original SW algorithm is expressed for an nxm matrix H, representing the two strings of length n and m, in terms of equation (1):

H_k0=H_0l=0 (for 0≦k≦n and 0≦l≦m)

H_ij=max{H_(i−1,j−1)+s(a_i,b_j),H_(i−1,j)−W_in,H_(i,j−1)−W_del,0}(for 1≦i≦n and 1≦j≦m) (1)

In the equations above, s(ai,bj) represents either a match bonus (when ai=bj) or a mismatch penalty (when ai ≠ bj), and insertions and deletions are given the penalties Win and Wdel, respectively. In most instances, the resulting matrix has many elements that are zero. This representation makes it easier to backtrace from high-to-low, right-to-left in the matrix, thus identifying the alignment.

Once the matrix has been fully populated with scores, the SW algorithm performs a backtrack to determine the alignment. Starting with the maximum value in the matrix, the algorithm will backtrack based on which of the three values (Hi−1,j−1, Hi−1,j, or Hi,j−1) was used to compute the final maximum value for each cell. The backtracking stops when a zero is reached. The optimal-scoring alignment may contain greater than the minimum possible number of insertions and deletions, while containing far fewer than the maximum possible number of substitutions.

SW or SW-Gotoh may be implemented using dynamic programming to perform local sequence alignment of the two strings, S and A, of sizes m and n, respectively. This dynamic programming employs tables or matrices to preserve match scores and avoid re-computation for successive cells. Each element of the string can be indexed with respect to a letter of the sequence, that is, if S is the string ATCGAA, S[1]=A.

Instead of representing the optimum alignment as Hi,j (above), the optimum alignment can be represented as B[j,k] in equation (2) below:

B[j, k]=max(p[j, k], i[j, k], d[j, k], 0) (for 0<j≦m, 0<k≦n) (2)

The arguments of the maximum function, B[j,k], are outlined in equations (3)-(5) below, wherein MISMATCH_PEN, MATCH_BONUS, INSERTION_PEN, DELETION_PEN, and OPENING_PEN are all constants, and all negative except for MATCH_BONUS (PEN is short for PENALTY). The match argument, p[j,k], is given by equation (3), below:

p[j,k]=max(p[j−1,k−1], i[j−1,k−1], d[j−1,k−1])+MISMATCH_PEN, if S[j] ≠ A[k]=max(p[j−1,k−1], i[j−1,k−1], d[j−1,k−1])+MATCH_BONUS, if S[j]=A[k] (3)

the insertion argument i[j,k], is given by equation (4), below:

i[j,k]=max(p[j−1,k]+OPENING_PEN, i[j−1,k], d[j−1,k]+OPENING_PEN)+INSERTION_PEN (4)

and the deletion argument d[j,k], is given by equation (5), below:

d[j,k]=max(p[j,k−1]+OPENING_PEN, i[j,k−1]+OPENING_PEN, d[j,k−1])+DELETION_PEN (5)

For all three arguments, the [0,0] element is set to zero to assure that the backtrack goes to completion, i.e., p[0,0]=i[0,0]=d[0,0]=0.

The scoring parameters are somewhat arbitrary, and can be adjusted to achieve the behavior of the computations. One example of the scoring parameter settings (Huang, Chapter 3: Bio-Sequence Comparison and Alignment, ser. Curr Top Comp Mol Biol. Cambridge, Mass. The MIT Press, 2002) for DNA would be:

MATCH_BONUS: 10

MISMATCH_PEN: −20

INSERTION_PEN: −40

OPENING_PEN: −10

DELETION_PEN: −5

The relationship between the gap penalties (INSERTION_PEN, OPENING_PEN) above help limit the number of gap openings, i.e., favor grouping gaps together, by setting the gap insertion penalty higher than the gap opening cost. Of course, alternative relationships between MISMATCH_PEN, MATCH_BONUS, INSERTION_PEN, OPENING_PEN and DELETION_PEN are possible.

In some embodiments, the methods and systems of the invention use a modified Smith-Waterman operation that involves a multi-dimensional look-back through the multi-species genome graph 331. Multi-dimensional operations of the invention provide for a “look-back” type analysis of sequence information (as in Smith-Waterman), wherein the look back is conducted through a multi-dimensional space that includes multiple pathways and multiple nodes. The multi-dimensional algorithm can be used to align sequence reads against the graph-type reference. That alignment algorithm identifies the maximum value for Ci,j by identifying the maximum score with respect to each sequence contained at a position on the graph. In fact, by looking “backwards” at the preceding positions, it is possible to identify the optimum alignment across a plurality of possible paths.

The modified Smith-Waterman operation described here, aka the multi-dimensional alignment, provides exceptional speed when performed in a genomic graph system that employs physical memory addressing (e.g., through the use of native pointers or index free adjacency as discussed above). The combination of multi-dimensional alignment to a multi-species genome graph 331 with the use of spatial memory addresses (e.g., native pointers or index-free adjacency) improves what the computer system is capable of, facilitating whole genomic scale analysis to be performed using the methods described herein.

The operation includes aligning a sequence, or string, to a graph. For the purpose of defining the algorithm, let S be the string being aligned, and let D be the directed graph to which S is being aligned. The elements of the string, S, are bracketed with indices beginning at 1. Thus, if S is the string ATCGAA, S[1]=A, S[4]=G, etc.

In certain embodiments, for the graph, each letter of the sequence of a node will be represented as a separate element, d. In a preferred embodiment, node or edge objects contain the sequences and the sequences are stored as the longest-possible string in each object. A predecessor of d is defined as:

(i) If d is not the first letter of the sequence of its object, the letter preceding d in its object is its (only) predecessor;

(ii) If d is the first letter of the sequence of its object, the last letter of the sequence of any object that is a parent of d′s object is a predecessor of d.

The set of all predecessors is, in turn, represented as P[d].

In order to find the “best” alignment, the algorithm seeks the value of M[j,d], the score of the optimal alignment of the first j elements of S with the portion of the graph preceding (and including) d. This step is similar to finding Hi,j in equation 1 above. Specifically, determining M[j,d] involves finding the maximum of a, i, e, and 0, as defined below:

M[j, d]=max{a, i, e, 0} (6)

where

e=max{M[j, p*]+DELETE_PEN} for p* in P[d]

i=M[j−1, d]+INSERT_PEN

a=max {M[j−1, p*]+MATCH_SCORE} for p* in P[d], if S[j]=d;

max{M[j−1, p*]+MISMATCH_PEN} for p* in P[d], if S[j] ≠d

As described above, e is the highest of the alignments of the first j characters of S with the portions of the graph up to, but not including, d, plus an additional DELETE_PEN. Accordingly, if d is not the first letter of the sequence of the object, then there is only one predecessor, p, and the alignment score of the first j characters of S with the graph (up-to-and-including p) is equivalent to M[j,p]+DELETE_PEN. In the instance where d is the first letter of the sequence of its object, there can be multiple possible predecessors, and because the DELETE_PEN is constant, maximizing [M[j, p*]+DELETE_PEN] is the same as choosing the predecessor with the highest alignment score with the first j characters of S.

In equation (6), i is the alignment of the first j−1 characters of the string S with the graph up-to-and-including d, plus an INSERT_PEN, which is similar to the definition of the insertion argument in SW (see equation 1).

Additionally, a is the highest of the alignments of the first j characters of S with the portions of the graph up to, but not including d, plus either a MATCH_SCORE (if the jth character of S is the same as the character d) or a MISMATCH_PEN (if the jth character of S is not the same as the character d). As with e, this means that if d is not the first letter of the sequence of its object, then there is only one predecessor, i.e., p. That means a is the alignment score of the first j−1 characters of S with the graph (up-to-and-including p), i.e., M[j−1,p], with either a MISMATCH_PEN or MATCH_SCORE added, depending upon whether d and the jth character of S match. In the instance where d is the first letter of the sequence of its object, there can be multiple possible predecessors. In this case, maximizing {M[j, p*]+MISMATCH_PEN or MATCH_SCORE} is the same as choosing the predecessor with the highest alignment score with the first j−1 characters of S (i.e., the highest of the candidate M[j−1,p*] arguments) and adding either a MISMATCH_PEN or a MATCH_SCORE depending on whether d and the jth character of S match.

Again, as in the SW algorithm, the penalties, e.g., DELETE_PEN, INSERT_PEN, MATCH_SCORE and MISMATCH_PEN, can be adjusted to encourage alignment with fewer gaps, etc.

As described in the equations above, the operation finds the optimal (e.g., maximum) value for a sequence read 205 to the multi-species genome graph 331 by calculating not only the insertion, deletion, and match scores for that element, but looking backward (against the direction of the graph) to any prior nodes on the graph to find a maximum score.

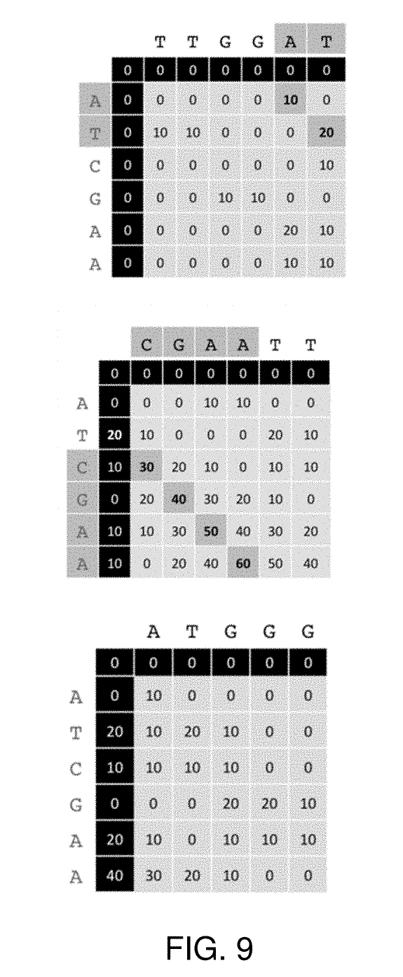

FIG. 9 shows the matrices that represent the comparison. The modified Smith-Waterman operation of the invention identifies the highest score and performs a backtrack to identify the proper alignment of the sequence. See, e.g., U.S. Pub. 2015/0057946 and U.S. Pub. 2015/0056613, both incorporated by reference. Systems and methods of the invention can be used to provide a report that identifies a modified base at the position within the genome of the subject. Other information may be found in Kehr et al., 2014, Genome alignment with graph data structures: a comparison, BMC Bioinformatics 15:99 and Lee, 2003, Generating consensus sequences from partial order multiple sequence alignment graphs, Bioinformatics 19(8):999-1008, both incorporated by reference. Thus, analyzing genomic information from nucleic acid from the sample 203 may include aligning 129 one or more of the sequence reads 205 to the multi-species reference graph 331 as shown in FIG. 8. The branches to which the reads 205 have been aligned are identified, along with the corresponding species.

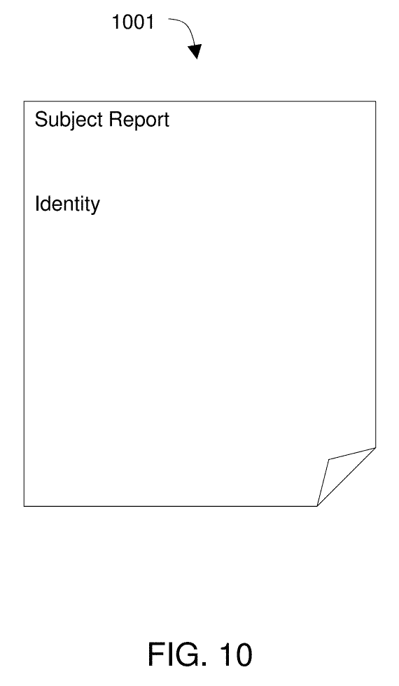

FIG. 10 illustrates a report 1001 that may be generated by the system 401. Preferably the report 1001 includes at least the identity for the genetic sequence from the organism. The report 1001 may also include information about the branches of the multi-species reference graph 331 to which the genetic sequence aligned, optionally with what percentage of sequence reads aligned (or percentage of nucleotides matched) to each. The report 1001 may include an identity of the organism.

For example, the report may identify a type of plant that the organism is. The reference graph may be pre-constructed with reference genomes for one or more of corn, wheat, maize, rapeseed, soybean, sunflower, barley, sorghum, potato, and rice. Thus the report 1001 may identify the organism as a plant such as corn, wheat, maize, rapeseed, soybean, sunflower, barley, sorghum, potato, or rice.

The report 1001 may identify a type of animal that the organism is. The reference graph 331 may be constructed with reference genomic information from one or more of cattle, horse, goat, sheep, swine, and poultry. The report 1001 may identify the organism as animal such as one of cattle, horse, goat, sheep, swine, and poultry.

Embodiments according to the disclosure may also be used for interspecies comparisons. The report 1001 may also identify particular breeds of animals. For example, the reference graph 331 may be constructed with reference genomic information from a variety of breeds of dogs. The report 1001 may identify the organism as a particular breed.

In some embodiments, systems and methods of the invention may be used in population genetics. The report may include information about a population that includes the organism. For example, the report may include an F-statistic describing heterozygosity within the population. The F-statistic may be, for example, F_{IS}, F_{ST}, or F_{IT}. In population genetics, F-statistics (also known as fixation indices) describe the statistically expected level of heterozygosity in a population and an expected degree of a reduction in heterozygosity when compared to Hardy-Weinberg equilibrium. F-statistics measure correlation between genes at different levels of a subdivided population. The correlation is influenced by processes such as mutation, migration, inbreeding, natural selection, or the Wahlund effect, and was originally designed to measure the amount of allelic fixation owing to genetic drift. F can be used to define effective population size. The measures F_{IS}, F_{ST}, and F_{IT} are related to the amounts of heterozygosity at various levels of population structure. Together, they are called F-statistics, and are derived from F, the inbreeding coefficient. In a simple two-allele system with inbreeding, the genotypic frequencies are: p̂{2}(1−F)+pF for AA; 2pq(1−F) for Aa}; q̂{2}(1−F)+qF for aa.

The value for F is found by solving for F using heterozygotes in a population. This becomes one minus the observed number of heterozygotes in a population divided by its expected number of heterozygotes at Hardy-Weinberg equilibrium. The different F-statistics look at different levels of population structure. F_{IT} is the inbreeding coefficient of an individual (I) relative to the total (T) population, as above; F_{IS} is the inbreeding coefficient of an individual (I) relative to the subpopulation (S), using the above for subpopulations and averaging them; and F_{ST} is the effect of subpopulations (S) compared to the total population (T). For background, see Wright, 1965, The Interpretation of Population Structure by F-Statistics with Special Regard to Systems of Mating, Evolution 19(3):395-420 and Holsinger et al., 2009, Genetics in geographically structured populations: defining, estimating, and interpreting FST, Nature Rev Genet 10(9):639-50, the contents of each of which are incorporated by reference. A reference graph 331 can be given edge weights that reflect empirically derived or otherwise estimated allele frequencies in a population. From those edge weights, any of the F statistics can be determined for any allele.

In certain embodiments, the known sequences from the plurality of different species comprising viral genetic information and human genetic information. The reference graph may represent the viral genetic information aligned to human endogenous retrovirus portions of the human genetic information.

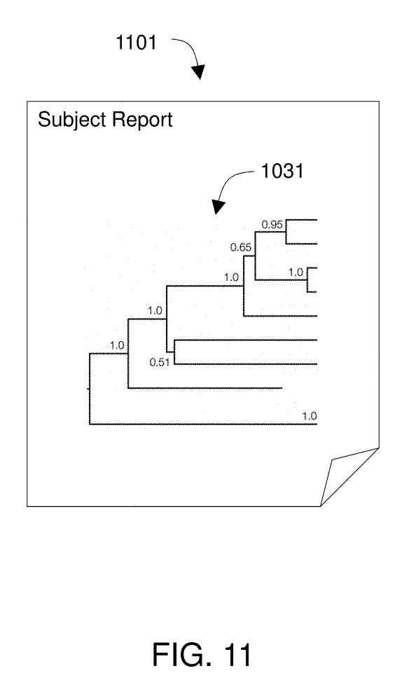

FIG. 11 illustrates a report 1101 that may be produced using systems and methods of the invention. Systems and methods of the invention may be used in classification such as within phylogenetics or cladistics. The report 1101 may identify a relationship between the organism and one of the plurality of different species. The report may include a phylogenetic tree that depicts the identified relationship. The system 401 may be used to generate the phylogenetic tree (e.g., using maximum likelihood using a program such as RxML; Bayesian inference using a program such as MrBayes; parsimony with a program such as PAUP*; genetic distance; or a genetic algorithm for rapid likelihood inference using a program such as GARLi).

As discussed above briefly in connection with FIG. 8, optionally, systems and methods of the invention may be used for variant calling 807 to produce genotype information 831 about an organism. Specifically, methods of the invention include obtaining a genetic sequence from an organism and aligning the sequence to one or more of a plurality of known sequences from a plurality of different species stored as a reference graph. A variant in the genetic sequence, relative to the reference graph is identified and “called” (e.g., reported out as a variant in the genetic sequence). The variant calling can include aligning sequence reads to the graph and reporting SNP alleles in a format such as a Sequence Alignment Map (SAM) or a Variant Call Format (VCF) file. Some background may be found in Li & Durbin, 2009, Fast and accurate short read alignment with Burrows-Wheeler Transform. Bioinformatics 25:1754-60 and McKenna et al., 2010, The Genome Analysis Toolkit: a MapReduce framework for analyzing next-generation DNA sequencing data, Genome Res 20(9):1297-1303, the contents of each of which are incorporated by reference. Variant calling 831 produces results (“variant calls”) that may be stored as a sequence alignment map (SAM) or binary alignment map (BAM) file—comprising an alignment string (the SAM format is described, e.g., in Li, et al., The Sequence Alignment/Map format and SAMtools, Bioinformatics, 2009, 25(16):2078-9). Additionally or alternatively, output from the variant calling may be provided in a variant call format (VCF) file, e.g., in report 1001. A typical VCF file will include a header section and a data section. The header contains an arbitrary number of meta-information lines, each starting with characters ‘##’, and a TAB delimited field definition line starting with a single ‘#’ character. The field definition line names eight mandatory columns and the body section contains lines of data populating the columns defined by the field definition line. The VCF format is described in Danecek et al., 2011, The variant call format and VCFtools, Bioinformatics 27(15):2156-2158.

In some embodiments, methods of the invention include obtaining a genetic sequence from an organism and aligning the sequence to one or more of a plurality of known sequences from a plurality of different species stored as a reference graph. The genetic sequence from the organism may be one of a plurality of sequence reads and the method may further include aligning some of the plurality of sequence reads to a known conserved gene in the reference graph and assembling others of the plurality of sequence reads to each other. The known conserved gene may be, e.g., a ribosomal subunit, hemoglobin, a gene of the electron transport chain such as cytochrome c, or any other suitable gene. In the various disclosed embodiments, aligning a genetic sequence to a reference graph can be described as converting the sequence into an alignment by using the processor to perform a multi-dimensional look-back operation to find a highest-scoring trace through a multi-dimensional matrix. The objects of the reference graph may include pointers to adjacent ones of the objects such that the objects are linked into paths to represent the known sequences from the plurality of different species, wherein each pointer identifies a physical location in the memory subsystem at which the adjacent object is stored.

Objects of the reference graph may include vertex objects connected by edge objects and an adjacency list for each vertex object and edge object, wherein the adjacency list for a vertex object or edge object lists the edge objects or vertex objects to which that vertex object or edge object is adjacent. Each entry in an adjacency list may be a pointer to the adjacent vertex object or edge object, wherein each pointer identifies a physical location in the memory subsystem at which the adjacent object is stored. In some embodiments, the reference graph uses index-free adjacency to link the objects into paths to represent the known sequences from the plurality of different species. Further discussion may be found in U.S. Pub. 2013/0073214; U.S. Pub. 2013/0345066; U.S. Pub. 2013/0311106; U.S. Pub. 2013/0059740; U.S. Pub. 2012/0157322; U.S. Pub. 2015/0057946 and U.S. Pub. 2015/0056613, each incorporated by reference for all purposes.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for analyzing genetic information, the method comprising:
obtaining a genetic sequence from an organism; and
aligning, using a processor coupled to a tangible memory subsystem, the genetic sequence to one or more of a plurality of known sequences from a plurality of different species stored as a reference graph comprising objects in the tangible memory subsystem, wherein matching homologous segments of the known sequences are each represented by a single object in the reference graph, and further wherein each of the plurality of different species has at least a majority of least one chromosome represented by a path through the reference graph.

2. The method of claim 1, further comprising providing a report that includes a description of an aspect of the organism based on a result of the aligning step.

3. The method of claim 2, wherein:
a first one of the plurality of different species has at least a majority of a first chromosome represented by a first path through the reference graph;
a second one of the plurality of different species has at least a majority of a second chromosome represented by a second path through the reference graph, wherein the first chromosome and the second chromosome both comprise a known conserved gene that are represented by a first segment of the reference graph;
the first chromosome comprises a first genomic feature represented by the reference graph and not found in a genome of the second one of the plurality of different species; and
the second one of the plurality of different species comprises a second genomic feature represented by the reference graph and not found in a genome of the first one of the plurality of different species.

4. The method of claim 3, further comprising, prior to the aligning step:
obtaining the known sequences from the plurality of different species from an online sequence database;
finding the matching homologous segments of the known sequences; and
creating one of the objects in the tangible memory subsystem for each of the matching homologous segments and one of the objects for any unmatched segment of the known sequences, thereby transforming the known sequences from the online sequence database into the reference graph.

5. The method of claim 2, wherein the aspect of the organism included in the report comprises an identity of the organism.

6. The method of claim 5, further comprising identifying a type of plant that the organism is.

7. The method of claim 6, wherein the plant is selected from the group consisting of corn, wheat, maize, rapeseed, soybean, sunflower, barley, sorghum, potato, and rice.

8. The method of claim 5, further comprising identifying a type of animal that the organism is.

9. The organism of claim 8, wherein the animal is selected from the group consisting of cattle, horse, goat, sheep, swine, and poultry.

10. The method of claim 3, wherein the genetic sequence from the organism is one of a plurality of sequence reads and the method further includes aligning some of the plurality of sequence reads to the known conserved gene in the reference graph and assembling others of the plurality of sequence reads to each other.

11. The method of claim 10, wherein the known conserved gene is a ribosomal subunit.

12. The method of claim 3, wherein aligning the sequence to one or more of a plurality of known sequences comprises using the processor to perform a multi-dimensional look-back operation to find a highest-scoring trace through a multi-dimensional matrix.

13. The method of claim 3, wherein the report further includes information about a population that includes the organism.

14. The method of claim 13, wherein the report includes an F-statistic describing heterozygosity within the population and the F-statistic is selected from the group consisting of: F_{IS}, F_{ST}, and F_{IT}.

15. The method of claim 1, wherein the known sequences from the plurality of different species comprising viral genetic information and human genetic information, wherein the reference graph represents the viral genetic information aligned to human endogenous retrovirus portions of the human genetic information.

16. The method of claim 3, further comprising identifying a relationship between the organism and one of the plurality of different species.

17. The method of claim 16, wherein the report further comprises a phylogenetic tree that depicts the identified relationship.

18. The method of claim 17, further comprising generating the phylogenetic tree by subjecting the known sequences from the plurality of different species and the genetic sequence from the organism to a phylogenetic inference operation using an approach selected from the group consisting of: maximum likelihood; Bayesian; parsimony; genetic distance; and genetic algorithm for rapid likelihood inference.

19. The method of claim 3, wherein the objects of the reference graph include pointers to adjacent ones of the objects such that the objects are linked into paths to represent the known sequences from the plurality of different species, wherein each pointer identifies a physical location in the memory subsystem at which the adjacent object is stored.
